(19) United States
(12) Patent Application Publication
(10) Pub. No.: US 2021/0226244 A1
(43) Pub. Date: Jul. 22, 2021

(54) FUEL CELL MODULE

(71) Applicant: TOYOTA JIDOSHA KABUSHIKI KAISHA, Toyota-shi (JP)

(72) Inventor: Tomoaki UCHIYAMA, Sunto-gun (JP)

(73) Assignee: TOYOTA JIDOSHA KABUSHIKI KAISHA, Toyota-shi (JP)

(21) Appl. No.: 17/123,832

(22) Filed: Dec. 16, 2020

(30) Foreign Application Priority Data
Jan. 20, 2020 (JP) 2020-006895

(51) Int. Cl. H01M 8/248

(52) U.S. Cl. CPC H01M 8/248; H01M 2250/20

(57) ABSTRACT

The invention provides a fuel cell module that can inhibit reduction in the load applied to the fuel cell stack and that can facilitate assembly. In the fuel cell module of this disclosure, each end plate has a groove on the side not facing the fuel cell stack, as viewed in the stacking direction of the fuel cell stack. Each fastening member also has a band part, and an anchoring part that is disposed on at least one end of the band part. The anchoring part is connected to the end plate by the connecting member, the tip section of the anchoring part having a shape complementary to the groove of the end plate in at least one direction within the plane of the end plate, and being fitted into the groove of the end plate, whereby the fastening member is fastened to the end plate.

### FIELD

The present disclosure relates to a fuel cell module.

### BACKGROUND

Fuel cell modules are known that have a fuel cell stack in which multiple fuel cells are stacked, and a pair of end plates clamping the fuel cell stack in the stacking direction of the fuel cell stack, and that are provided with a load-applying mechanism that applies a load between the pair of end plates in the stacking direction.

In the fuel cell module disclosed in PTL 1, the load is applied to the fuel cell stack by fastening of a fastening band between the pair of end plates. The same publication teaches that the fastening band is bent along the end plates (in a blocked “U” shape), and the fastening band and end plates are connected with bolts in the stacking direction of the fuel cell stack.

In the fuel cell module disclosed in PTL 2, fastening bands and end plates are connected by bolts in the in-plane direction of the end plates, i.e. in the direction perpendicular to the stacking direction of the fuel cell stack. In this publication it is stated that the fastening plates and end plate are positioned by pins so that shear force is not exerted on the bolts by fastening.

In the fuel cell module disclosed in PTL 3, fastening plates and end plates have a protrusion provided on one member and a recess provided on the other member, whereby the members are anchored.

In the fuel cell module disclosed in PTL 4, the fastening plate is anchored to the end plate by a sleeve.

### CITATION LIST

### Patent Literature

### [PTL 1] Japanese Unexamined Patent Publication No. 2017-063017

### [PTL 2] Japanese Unexamined Patent Publication No. 2010-251065

### [PTL 3] Japanese Unexamined Patent Publication No. 2017-152116

### [PTL 4] Japanese Unexamined Patent Publication No. 2019-140004

### SUMMARY

### Technical Problem

When the fuel cell module has been mounted in a vehicle, for example, sudden starting, vibration or collision of the vehicle can potentially create force in the direction perpendicular to the stacking direction of the fuel cell stack. When the fuel cell module is mounted in a vehicle, for example, it may not be mountable with the stacking direction situated vertically due to mounting space constraints, and in cases where it has been mounted diagonally, its own weight can potentially create force in the direction perpendicular to the stacking direction of the fuel cell stack.

When applying a fuel cell module employing a construction where the fuel cell stack is constrained by fastening end plates and a fastening member using connecting members such as connecting bolts, for example, as disclosed in PTL 1, the present inventors have found that force applied in the in-plane direction of the end plates can cause shearing force to be exerted on the connecting members, leading to breakage of the connecting members, and that this can lower the load applied to the fuel cell stack and consequently lower the power generation performance of the fuel cell module.

In addition, the fuel cell modules disclosed in PTLs 2 to 4 make use of multiple parts to constrain the fuel cell stack. The present inventors have found that from the viewpoint of facilitating assembly of the fuel cell module, it is desirable to reduce the number of parts used to constrain the fuel cell stack.

It is an object of the present disclosure to provide a fuel cell module that can have less reduction in load applied to the fuel cell stack and that can facilitate assembly.

### Solution to Problem

The present inventors have found that this object can be achieved by the following means.

### Aspect 1

A fuel cell module comprising:

a fuel cell stack in which one or more fuel cell unit cells are stacked together,

a pair of end plates clamping the fuel cell stack in the stacking direction of the fuel cell stack, and

fastening members fastened to the pair of end plates, thereby constraining the fuel cell stack,

wherein:

each end plate has grooves on the side not facing the fuel cell stack, as viewed in the stacking direction of the fuel cell stack,

each fastening member has a band part and an anchoring part that is disposed on at least one end of the band part, and

the anchoring part is connected to the end plate by a connecting member, the tip section of the anchoring part having a shape complementary to a groove of the end plate in at least one direction within the plane of the end plate, and being fitted with the groove of the end plate, whereby the fastening member is fastened to the end plate.

### Aspect 2

The fuel cell module according to aspect 1, wherein the anchoring part is disposed at both ends of the band part of the fastening member.

### Aspect 3

The fuel cell module according to aspect 1 or 2, wherein the tip section of the anchoring part has a shape that is complementary to the shape of the groove of the end plate in all directions within the plane of the end plate, as viewed in the stacking direction of the fuel cell stack.

### Aspect 4

The fuel cell module according to any one of aspects 1 to 3, wherein the tip section of the anchoring part protrudes toward the end plate side, as viewed in the direction perpendicular to the stacking direction of the fuel cell stack.

### Aspect 5

The fuel cell module according to any one of aspects 1 to 4, wherein the tip section of the anchoring part differs in thickness from its other parts.

### Aspect 6

The fuel cell module according to any one of aspects 1 to 5, wherein the band part and the anchoring part of the fastening member are different parts, and are welded together.

### Aspect 7

The fuel cell module according to any one of aspects 1 to 5, wherein the fastening member is formed by a single part.

### Advantageous Effects of Invention

According to the present disclosure it is possible to provide a fuel cell module that can inhibit reduction in the load applied to the fuel cell stack and that can facilitate assembly.

### BRIEF DESCRIPTION OF DRAWINGS

FIG. 1 is a schematic diagram showing a fuel cell module 1 according to a first embodiment of the disclosure.

FIG. 2 is a schematic view showing an end plate 12 of the fuel cell module 1 according to the first embodiment of the disclosure.

FIG. 3 is a schematic diagram showing a fastening member 13 of the fuel cell module 1 according to the first embodiment of the disclosure.

FIG. 4 is a schematic diagram of the fuel cell module 1 of the first embodiment of the disclosure, as seen from cross-section A-A′ of FIG. 1.

FIG. 5 is a magnified view of the portion indicated as X in FIG. 4.

FIG. 6 is a schematic diagram showing part of a fastening member 13 of a fuel cell module 1 according to a second embodiment of the disclosure.

FIG. 7 is a schematic diagram showing part of a fastening member 13 of a fuel cell module 1 according to a third embodiment of the disclosure.

FIG. 8 is a schematic diagram showing part of the fastening member 13 of a fuel cell module 1 according to a fourth embodiment of the disclosure.

### DESCRIPTION OF EMBODIMENTS

Embodiments of the disclosure will now be explained in detail. The disclosure is not limited to the embodiments described below, however, and various modifications may be implemented which do not depart from the gist thereof.

The fuel cell module of the disclosure has a fuel cell stack in which one or more fuel cell unit cells are stacked together, a pair of end plates clamping the fuel cell stack in the stacking direction of the fuel cell stack, and fastening members that are fastened to the pair of end plates, thereby constraining the fuel cell stack.

In the fuel cell module of the disclosure, each end plate has grooves on the side not facing the fuel cell stack, as viewed in the stacking direction of the fuel cell stack. Each fastening member also has a band part, and an anchoring part that is disposed on at least one end of the band part. The anchoring part is connected to the end plate by the connecting member, the tip section having a shape complementary to a groove of the end plate in at least one direction within the plane of the end plate, and being fitted into the groove of the end plate, whereby the fastening member is fastened to the end plate.

In the fuel cell module of the disclosure, the tip section of the anchoring part of the fastening member has a shape complementary to the groove of the end plate in at least one direction within the plane of the end plate, and it is fitted into the groove of the end plate. That is, the fastening member is fitted into the groove of the end plate so that it does not move in at least one direction relative to the end plate.

Thus, even when force is applied from outside the fuel cell module in that direction within the plane of the end plate, for example, and more specifically, when the fuel cell module has collided with another object or has experienced vibration, variation in the relative positional relationship between the end plate and the anchoring part of the fastening member is reduced. This reduces shearing force exerted on the connecting member by variation in the relative positional relationship of the end plates and the anchoring part of the fastening member.

It is thus possible to inhibit reduction in the load applied to the fuel cell stack caused by breakage of the connecting members. Reduction in power generation performance of the fuel cell module can thus be reduced.

In addition, the fuel cell module of the disclosure has the anchoring part of each fastening member connected to the end plate by the connecting member, and since the tip section of the anchoring part has a shape complementary to the groove of the end plate in at least one direction within the plane of the end plate and is fitted with the groove of the end plate, the fastening member can be fastened to the end plate so that it does not move in at least one direction relative to the end plate. In other words, the fuel cell module of the disclosure can have the fastening member fastened to each end plate with a small number of parts. The fuel cell module of the disclosure is therefore easy to assemble.

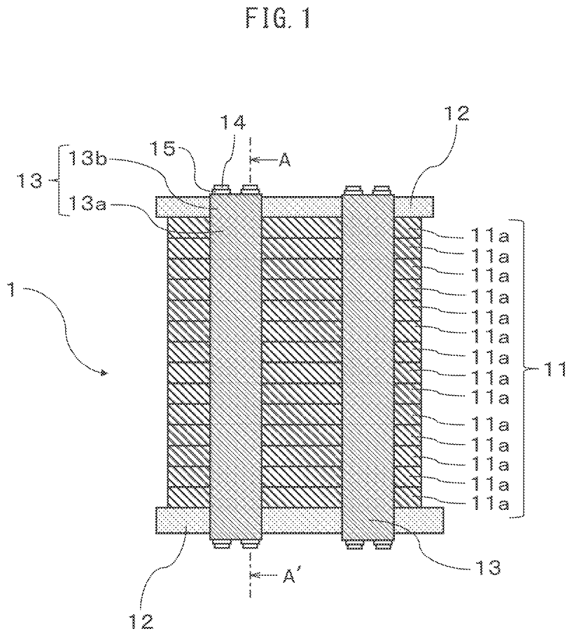

FIGS. 1 to 5 are schematic diagrams showing a fuel cell module 1 according to the first embodiment of the disclosure.

As shown in FIG. 1, the fuel cell module 1 according to the first embodiment of the disclosure has a fuel cell stack 11 in which one or more fuel cell unit cells 11a are stacked together, a pair of end plates 12 clamping the fuel cell stack 11 in the stacking direction of the fuel cell stack 11, and fastening members 13 that are fastened to the pair of end plates 12, thereby constraining the fuel cell stack 11.

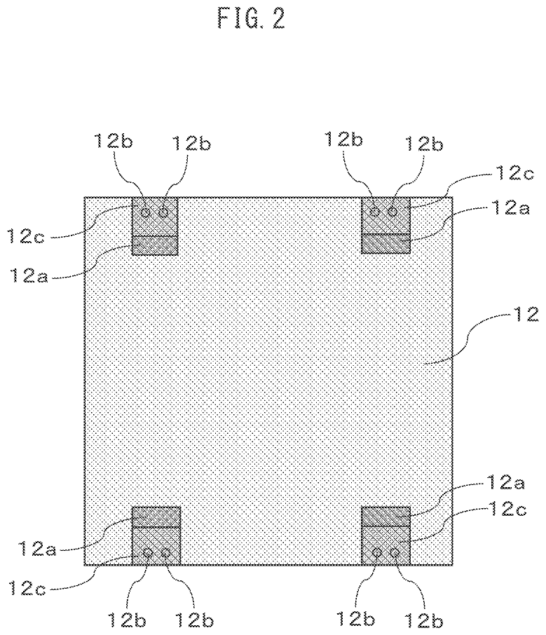

As shown in FIG. 2, each end plate 12 of the fuel cell module 1 according to the first embodiment of the disclosure, as viewed in the stacking direction of the fuel cell stack 11, has grooves 12a for fitting with the tip sections 13c of the anchoring parts 13b of each of the fastening members 13, on the side that is not facing the fuel cell stack 11. The end plate 12 has bolt holes 12b for insertion and anchoring of bolts 14 serving as connecting members, and grooves 12c that span the sections that contact with the anchoring parts 13b of the fastening members 13. The grooves 12a for fitting of the tip sections 13c of the anchoring parts 13b of the fastening members 13 are deeper grooves than the grooves 12c spanning the sections that contact with the anchoring parts 13b of the fastening members 13.

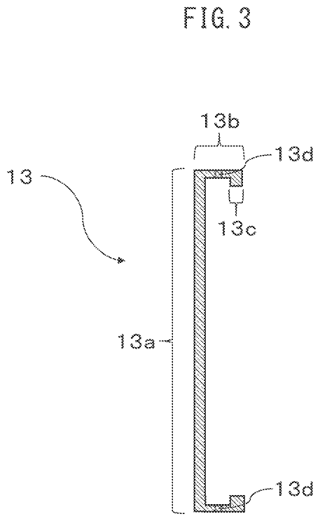

As shown in FIG. 3, each fastening member 13 of the fuel cell module 1 of the first embodiment of the disclosure has a band part 13a and anchoring parts 13b disposed at both ends of the band part 13a. When the fuel cell module 1 is in the assembled state, the band part 13a extends between the pair of end plates 12 and on the side surfaces of the fuel cell stack 11. Moreover, when the fuel cell module 1 is in the assembled state, each anchoring part 13b extends on the side of the end plate 12 that is not facing the fuel cell stack 11, and each tip section 13c of the anchoring part 13b protrudes to the end plate 12 side, as viewed in the direction perpendicular to the stacking direction of the fuel cell stack 11. Each tip section 13c of the anchoring part 13b has a shape complementary to the groove 12a of the end plate 12 in at least one direction within the plane of the end plate 12. The anchoring part 13b also has a through-hole 13d for a bolt 14 to allow insertion of the bolt as the connecting member.

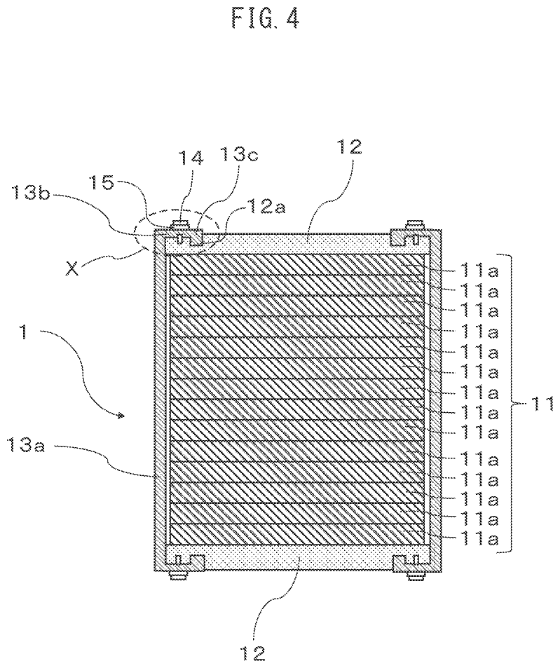

FIG. 4 is a schematic diagram of the fuel cell module 1 of the first embodiment of the disclosure, as seen from cross-section A-A′ of FIG. 1. As shown in FIG. 4, the anchoring part 13b of the fastening member 13 is connected to the end plate 12 by a bolt 14 serving as the connecting member. The tip section 13c of the anchoring part 13b has a complementary shape in at least one direction within the plane of the end plate 12 (the right-left direction in FIG. 4). The tip section 13c of the anchoring part 13b is thus fitted into the groove 12a of the end plate 12 so that it does not move in at least one direction within the plane of the end plate 12 (the right-left direction in FIG. 4). A washer 15 is also disposed between the bolt 14 and the anchoring part 13b of the fastening member 13.

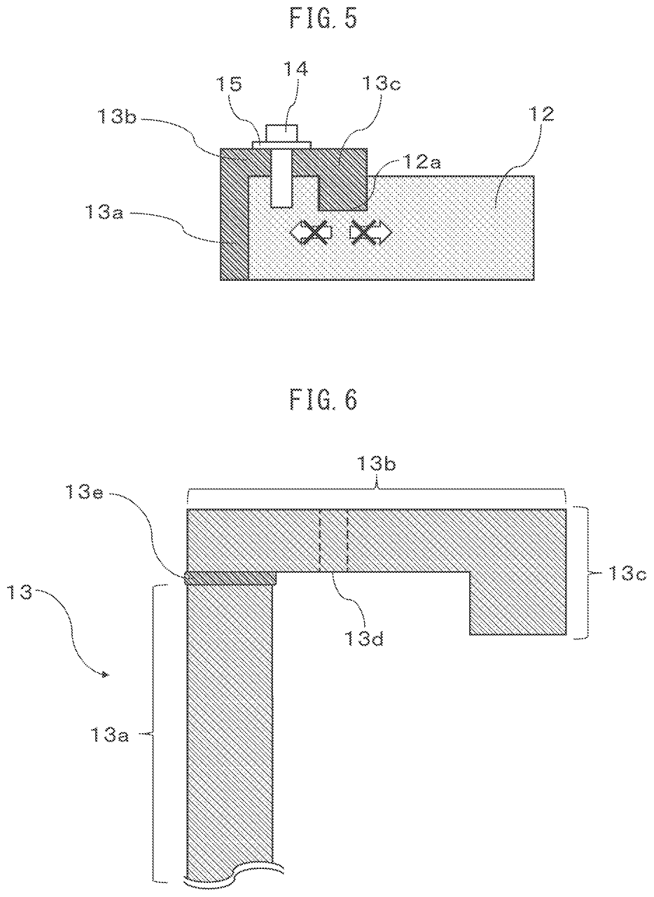

FIG. 5 is a magnified view of the portion indicated as X in FIG. 4. As shown in FIG. 5, in the fuel cell module 1 according to the first embodiment of the disclosure, the anchoring part 13b of the fastening member 13 is connected to the end plate 12 by the bolt 14 serving as the connecting member, and the tip section 13c of the anchoring part 13b is fitted into the groove 12a of the end plate 12 so that it does not move in at least one direction within the plane of the end plate 12 (the right-left direction in FIG. 5). Even when force is applied from outside of the fuel cell module 1 in a direction within the plane of the end plate 12, for example, variation in the relative positional relationship between the end plate 12 and the anchoring part 13b of the fastening member 13 is inhibited, as indicated by the white arrows and X marks. This reduces shearing force exerted on the bolt 14 by variation in the relative positional relationship between the end plate 12 and the anchoring part 13b of the fastening member 13.

### Fuel Cell Stack

The fuel cell stack comprises one or more fuel cell unit cells stacked together.

The number of fuel cell unit cells in the fuel cell stack is one or more. The number of fuel cell unit cells in the fuel cell stack may be appropriately selected depending on the purpose of use of the fuel cell module. The number of fuel cell unit cells in the fuel cell stack may be from 1 to 1000, for example. The number of fuel cell unit cells in the fuel cell stack may be one or more, 50 or more or 100 or more, and up to 1000, up to 500 or up to 200. The number of fuel cell unit cells in the fuel cell stack will typically be about 100.

The fuel cell unit cell may have a construction comprising, for example, a cathode separator layer, a cathode gas diffusion layer, a cathode catalyst layer, an electrolyte layer, an anode catalyst layer, an anode gas diffusion layer and an anode separator layer, stacked in that order.

The stacking direction of the fuel cell stack, i.e. the direction in which the fuel cell unit cells are layered, may match the stacking direction of the fuel cell unit cells, i.e. the direction in which the individual layers of the fuel cell unit cells are layered.

The material and shape of the fuel cell stack may be any material and shape commonly employed for fuel cell modules.

### End Plates

The pair of end plates are members that clamp the fuel cell stack in the stacking direction of the fuel cell stack, and they are fastened with the fastening members.

Each end plate has grooves on the side not facing the fuel cell stack, as viewed in the stacking direction of the fuel cell stack. Each groove is made so that the tip section of the anchoring part of the fastening member fits in a manner so that it does not move in at least one direction within the plane of the end plate. The groove preferably does not penetrate through the end plate.

The end plate may also have other grooves in addition to these grooves. The other grooves may be bolt holes or screw holes, for example, when the connecting members serving to connect the anchoring parts of the fastening members with the end plates are bolts or screws. The other grooves may be, but are not limited to, grooves for guiding the anchoring parts of the fastening members to the proper locations on the end plates. Such grooves preferably do not penetrate through the end plates.

The material of each end plate is not particularly restricted, and it may be a metal such as stainless steel, or fiber-reinforced plastic such as carbon fiber reinforced plastic or glass fiber reinforced plastic.

The shape of the end plate may be any shape that allows pressure applied by the fastening members that constrain the fuel cell stack from outside of the end plates, to be transmitted to the fuel cell stack.

### Fastening Members

The fastening members are fastened to the pair of end plates, thereby constraining the fuel cell stack.

Each fastening member has a band part, and an anchoring part that is disposed on at least one end of the band part. Anchoring parts are preferably disposed at least at both ends of the band part.

Each anchoring part is connected to the end plate by a connecting member, with its tip section fitted into the groove of the end plate so that it does not move in at least one direction within the plane of the end plate.

The thicknesses of the tip section and the other parts of the anchoring part may be identical or different. When the connecting member used to connect the anchoring part to the end plate is a bolt, the anchoring part may have a through-hole for the bolt.

The tip section of the anchoring part may have any desired shape that allows it to be fitted into the groove of the end plate so that it does not move in at least one direction within the plane of the end plate.

The tip section preferably has a shape that is complementary to the shape of the groove of the end plate, as viewed in the stacking direction of the fuel cell stack. If the tip section has a shape that is complementary to the shape of the groove of the end plate, then the tip section will not move relative to any of the directions within the plane of the end plate, thus inhibiting shearing force from being exerted onto the connecting member by variation in the relative positional relationship between the end plate and the anchoring part of the fastening member, in all directions within the plane of the end plate.

The tip section may have a shape that protrudes toward the end plate side as viewed in the direction perpendicular to the stacking direction of the fuel cell stack. More specifically, the tip section may have a shape that rises on the end plate side, or that is bent, as viewed in the direction perpendicular to the stacking direction of the fuel cell stack.

For the present disclosure, the fastening member may be composed of a single part or it may be composed of multiple parts. Specifically, the fastening member may have the band part and anchoring part as different parts which are connected together by welding or the like. The fastening member may also have the band part and anchoring part formed of a single part.

The material of each fastening member may be a metal such as stainless steel, or fiber-reinforced plastic such as carbon fiber reinforced plastic or glass fiber reinforced plastic.

FIG. 6 is a schematic diagram showing part of the fastening member 13 of a fuel cell module 1 according to a second embodiment of the disclosure. In FIG. 6, the band part 13a and anchoring part 13b of the fastening member 13 are different parts which are welded together at a joint 13e. The tip section 13c of the anchoring part 13b has a shape that rises up on the end plate 12 side, as viewed in the direction perpendicular to the stacking direction of the fuel cell stack, so that it protrudes out on the end plate 12 side. The anchoring part 13b has a through-hole 13d for a bolt.

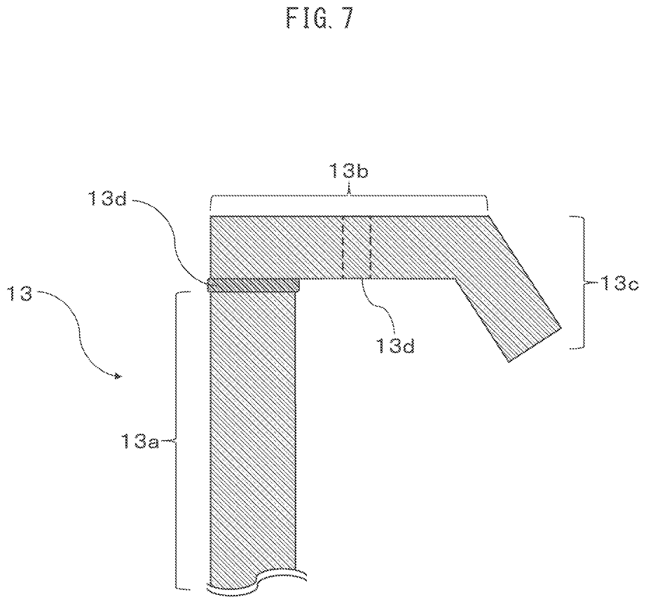

FIG. 7 is a schematic diagram showing part of the fastening member 13 of a fuel cell module 1 according to the third embodiment of the disclosure. The fuel cell module 1 of the third embodiment of the disclosure shown in FIG. 7 is the same as the fuel cell module 1 of the second embodiment of the disclosure shown in FIG. 6, except for the shape of the tip section 13c of the anchoring part 13b. In the fuel cell module 1 of the third embodiment of the disclosure, as shown in FIG. 7, the tip section 13c of the anchoring part 13b is bent on the end plate 12 side, as viewed in the direction perpendicular to the stacking direction of the fuel cell stack, thereby protruding out from the end plate 12 side.

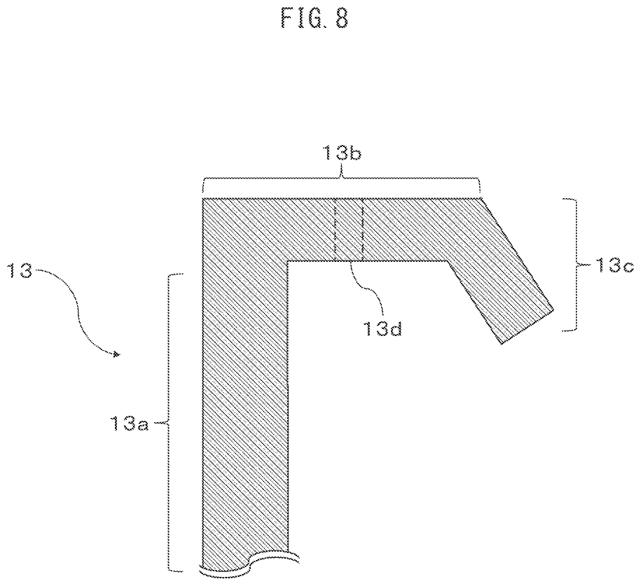

FIG. 8 is a schematic diagram showing part of the fastening member 13 of a fuel cell module 1 according to the fourth embodiment of the disclosure. In the fuel cell module 1 of the fourth embodiment of the disclosure shown in FIG. 8, the band part 13a and anchoring part 13b of the fastening member 13 are formed of a single part.

### Connecting Members

The connecting members may be any members allowing the anchoring parts of the fastening members to be connected to the end plates. Examples of connecting members include, but are not limited to, screws, machine screws, bolts and pins.

None of the drawings used throughout this disclosure are intended to place any limitations on the construction of the fuel cell module of the disclosure.

### REFERENCE SIGNS LIST

1 Fuel cell module
11 Fuel cell stack
11a Fuel cell unit cell
12 End plate

### 12a Groove

12b Bolt hole
12c Groove spanning section contacting with anchoring part 1 of fastening member
13 Fastening member
13a Band part
13b Anchoring part
13c Tip section
13d Through-hole for bolt

### 13e Joint

### 14 Bolt

1. A fuel cell module comprising:
a fuel cell stack in which one or more fuel cell unit cells are stacked together,
a pair of end plates clamping the fuel cell stack in the stacking direction of the fuel cell stack, and
fastening members fastened to the pair of end plates, thereby constraining the fuel cell stack,
wherein:
each end plate has grooves on the side not facing the fuel cell stack, as viewed in the stacking direction of the fuel cell stack,
each fastening member has a band part and an anchoring part that is disposed on at least one end of the band part, and
the anchoring part is connected to the end plate by a connecting member, the tip section of the anchoring part having a shape complementary to a groove of the end plate in at least one direction within the plane of the end plate, and being fitted with the groove of the end plate, whereby the fastening member is fastened to the end plate.

2. The fuel cell module according to claim 1, wherein the anchoring part is disposed at both ends of the band part of the fastening member.

3. The fuel cell module according to claim 1, wherein the tip section of the anchoring part has a shape that is complementary to the shape of the groove of the end plate in all directions within the plane of the end plate, as viewed in the stacking direction of the fuel cell stack.

4. The fuel cell module according to claim 1, wherein the tip section of the anchoring part protrudes toward the end plate side, as viewed from the direction perpendicular to the stacking direction of the fuel cell stack.

5. The fuel cell module according to claim 1, wherein the tip section of the anchoring part differs in thickness from its other parts.

6. The fuel cell module according to claim 1, wherein the band part and the anchoring part of the fastening member are different parts, and are welded together.

7. The fuel cell module according to claim 1, wherein the fastening member is formed by a single part.
